(19) United States
(12) Patent Application Publication
(10) Pub. No.: US 2005/0126092 A1
(43) Pub. Date: Jun. 16, 2005

(54) Cat and dog door

(76) Inventor: Kenneth Wayne Guy, Ukiah, CA (US)

Correspondence Address: Kenneth Guy, 5529 N. Old Settlers Rd., Morgantown, IN, 46160, US

(21) Appl. No.: 10/409,495

(22) Filed: Aug. 28, 2003

(51) Int. Cl. E06B 3/32

(52) U.S. Cl. 52/204.51

(57) ABSTRACT

The pet entrance is for the pet lover that can enjoy the indoor or outside climate by means of having the model of choice. One model is for an air conditioning where one can use the paneling model or Plexiglas and one is for the person who likes screen to allow air to flow. These models are for the pet and owner meaning the door fits for either a large pet or for a smaller pet. The door is smaller and the insert is also. The window model is for cats but, expands to fit all common models of windows. These models are for the sliding glass door entrance and the room window.

The Invention is for the pet and owner in which the both can benefit from the Invention. The door allows the pet to freely enter and exit the room with out bothering the owner. Each entrance is of the size for the best user of the door. The intendance is sized to fit in both a sliding glass door and window. The difference is depending on model. The window version is just for cats and is one size with the exception of different paneling or screen for air exchange. The window version comes with a pad for the outside of the window allowing the cat to have a pad to jump on before entering the window door. The sliding glass door model has two sizes because of the different size of pets. This model has options of metal paneling. Plexiglas paneling or screen for ventilation. The height and width are uniform with sliding door entrances.

The process for making these Inventions is as follows. Aluminum bar stock of two kinds and two colors one aluminum finish and one bronze. One bar stock is same grooved channel on both sides with the other side flat finish. The other stock is grooved and channeled one side the side used for the installation of the sheet metal stock or wire screening. Then there is round ⅛^{th} dia. Rope type of rubber holding cord that holds the wire screening in place and is installed in the grove of the bar stock. The wire mesh screening is roll stock type cut to fit. The rubber insert holding is from roll rubber glazing stock. Then there is the doors the doors are made of plastic simulated to look like wood and is of brown finish. This is also from sheet stock cut out to fit the size made for the pet door. The hinges that hold the door in place are simple hinges of ⅛ in. thick and the ¼ in. screws that comply with the hinges. Then there are the rip bits fasteners that hold the parts together.

The bar stock is measured out to the specification in the drawing figures of the Abstracts of specifications, and then cut to the lengths specified. They are cut at the 45 degree angles to be fastened together. Depending on the model is determined whether the paneling is inserted before the square stock is installed or not until. Thus if screen is the model then the bar stock is installed after the sheet stock is installed. After all parts are cut to the measurements and angled at the degree then it is put together with rabbit like fasteners. Then the handle is attached by screws. The plastic sliders are affixed to the top in the channel. The rollers are affixed to the bottom in the channel to allow sliding back and forth to be out of way of the user.

All the parts come to the table of assembly then put together in sections allowing the assembler to adjust to fit before the holes are drilled in place so the fasteners can be installed. Then as the assembly goes down the line it is welded with wire fed aluminum braised (Meg flux) at the bar stock section of the cross bar that holds the door sectional and the bottom of the screen or panel in place. Then the door is installed and the handle is installed. Then the castors rollers are installed and then the plastic slides are installed. Inspections are done to insure quality control before boxed and shipped out.

This Invention is different from the pet door installed in a regular door of a house in that it is placed in the sliding glass door area and in the room window.

FIG. 1: shows the taller wider door unit by itself for the dog or cat This unit is 78 &¾ in. tall and 16&½ in. wide and ½ in thick made of Alminum extrusion anodized material. This unit is held together by rib its and screws

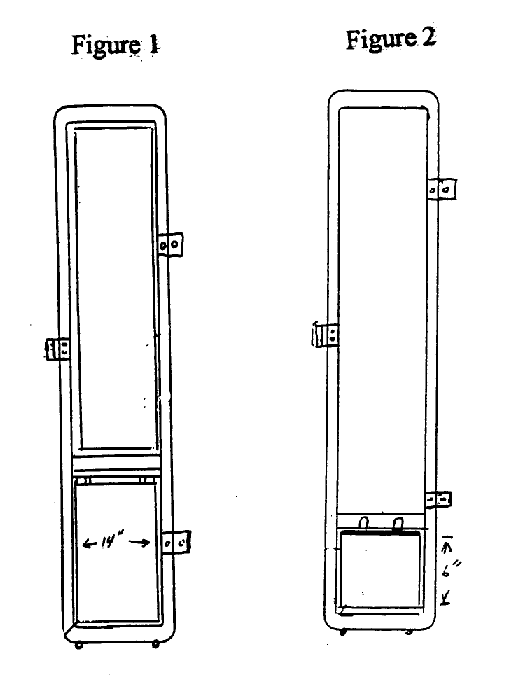

FIG. 2: Shows the smaller door unit for a smaller pet This unit is 78 &¾ in. tall and 8 in. wide and ½ in thick made of Aluminum extrusion anodized material. This unit is held together by rabbets and screws.

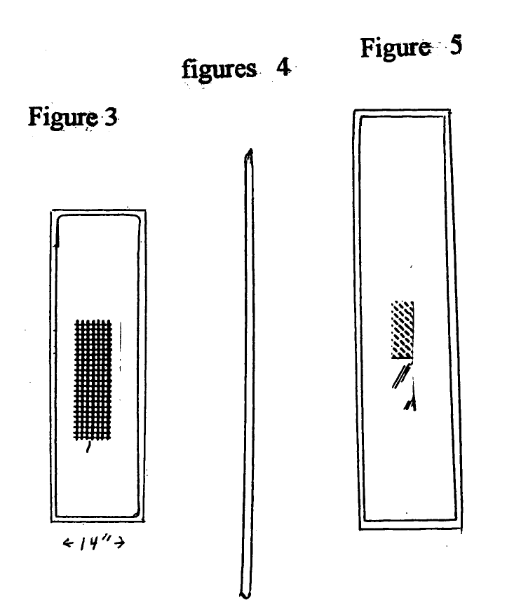

FIG. 3: shows the panel of the larger pet unit that is 14 in wide and 52 &½ in. tall. And 1/16^{th} of an in. thickness on the model with sheet metal. The other model comes with wire mesh screen.

FIG. 4 shows the Aluminum extruded or extrusion material as a bar stock as it come in 24 and 26 foot length This bar stock is channeled so the allow the insertion of wire screening or 1/16 in. thick sheet metal.

FIG. 5: shows the taller panel for the unit made for smaller pets. Unit that is 6 in. wide and 69 &¾ th in. tall. And 1/16^{th} of an in. thickness on the model with sheet metal. The other model comes with wire mesh screen.

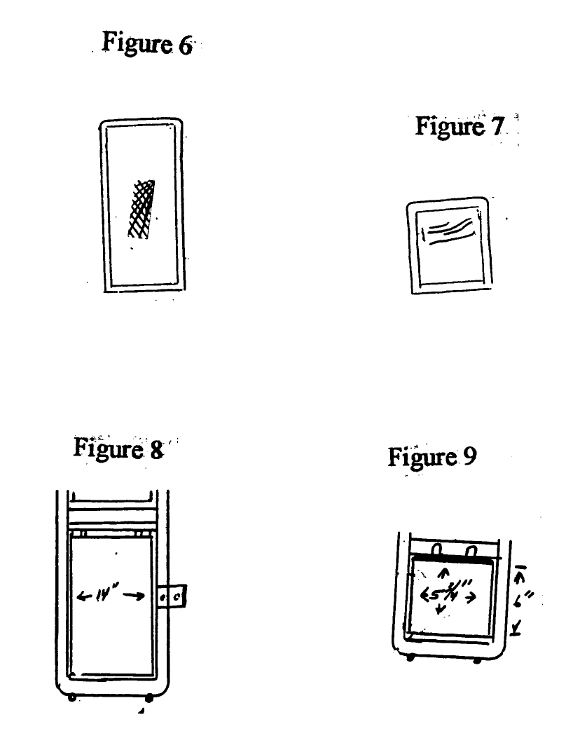

FIG. 6: shows the larger pet door that is 14 in. wide and 24 in. in height and ¼ in. thickness. This part is made of wood or can be simulated wood plastic. It can come in clear plastic or dark plastic.

FIG. 7: shows the smaller pet door that is 6 in. in height and 5 &¾ in. in width and ¼ in. thick. This part is made of wood or can be simulated wood plastic. It can come in clear plastic or dark plastic.

FIG. 8: shows the larger pet entrance with illustration of where the optional brace cam be placed, note there are holes pre-drilled in the spots where the braces and hinges should be places as well as the slider handle. This also shows where the hinges are to be placed.

FIG. 9: Shows the smaller pet door and where the hinges are to be placed or installed.

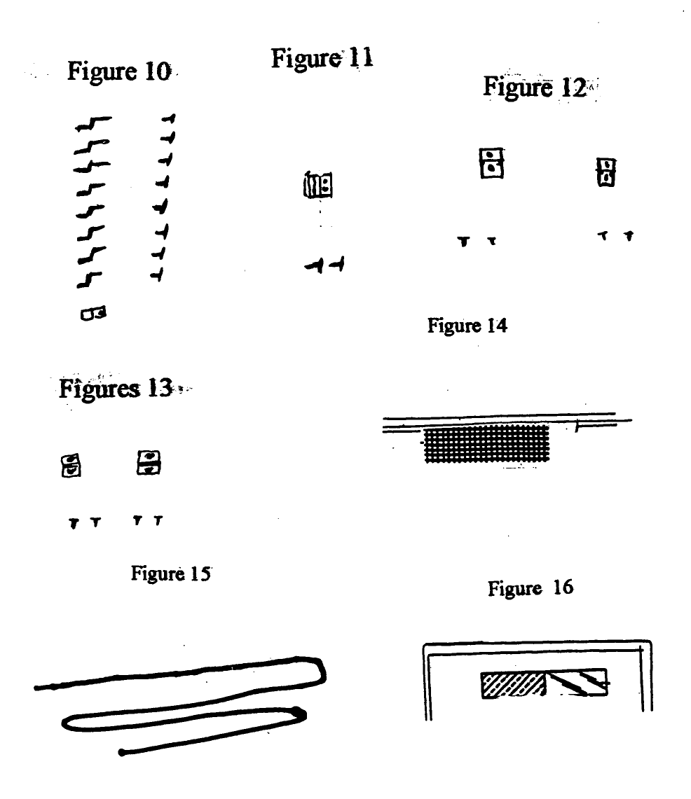

FIG. 10: Shows the 8 double L braces with the 8 screws that hold the screen or sheet metal or clear plastic panel in place in the unit.

FIG. 11: Shows the handle to allow the user to slide the unit out of the way of the general entrance. This is just a common handle of anodized aluminum ¼ in thick with 2 holes drilled in it for the attaching to the frame. The handle is equipped with 2 screws of ½ in. long and ¼ in dia.

FIG. 12: Shows the 2 brackets with 4 screws for the unit to be stabilized or attached These are ⅛ in. thick by 1 in. wide light metal brackets with ¼ in. screws.

FIG. 13; Shows the 2 hinges with 4 screws for the door to swing open and shut. These are ⅛ in. thick by 1 in. wide light metal hinges with ¼ in. screws.

FIG. 14: Shows the wire mesh type of screen that is part of the unit package allowing the consumer to use screen in the summer and metal or plastic in the winter.

FIG. 15: shows the rubber type of neoprene that holds the wire mesh screen in place in the frame of the panel. Note this is 160 in. long of 1/16^{th} in. in dia.

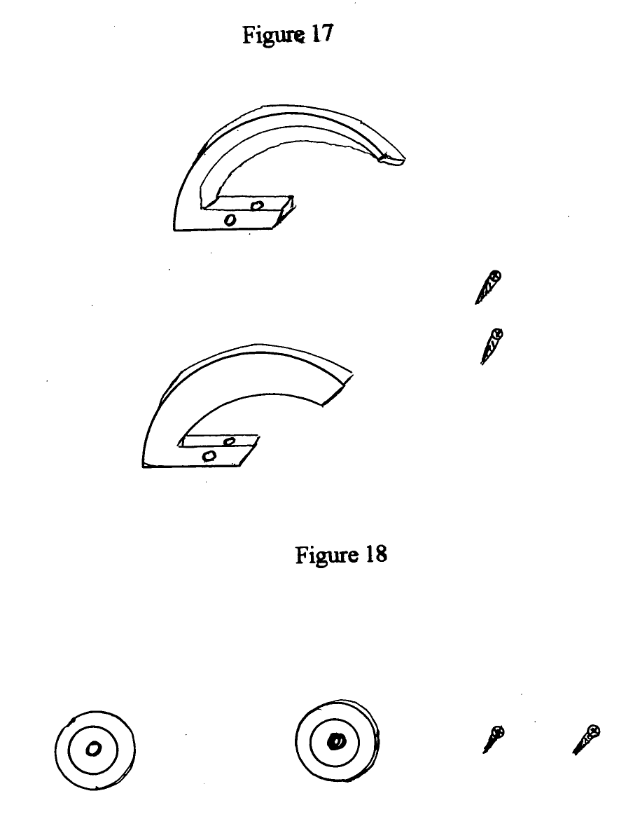

FIG. 16: Shows the Panel that is transparent clear plastic, note this is the panel that can be also placed with screen.

FIG. 17: shows 2 plastic casters that allow the unit to slide in the frame of the sliding door and hold the unit in place from the spring action it is pressing the unit in the frame and holding the rollers in place as well. These are ¼ wide by ¼ in thick and ½ in. height. They are held to the frame with 2 screws ½ in. long and 1/16^{th} in. dia.

FIG. 18: Shows the 2 rollers and 2 screws that hold the rollers in place. The rollers are ¼ in thick and ½ i dia The screws are ½ in. long and round at the roller head part then screwed tapered the other ¼ in. in length they are ⅛ in. in dia. as the holes are in the rollers.

Note: the frames are rib bitted together and have holes in all the places for the brackets, hinges and handle as well as the braces and rollers.

1. The Invention and Idea I named “Pet door” has four versions: the first three are units that can install in the sliding glass entryway to allow the pet or pets to enter and exit freely through out the year. The second is a cat only entry door for a sliding glass room window.

2. the user can change the invention and Idea for the right season via changing the panels from sheet stock to wire or plastic screen mesh. This allows the use to maintain air conditioning though out the year.
